(19) United States
(12) Patent Application Publication
(10) Pub. No.: US 2005/0246621 A1
(43) Pub. Date: Nov. 3, 2005

(54) Electronic paper display system

(75) Inventors: Toshiyuki Ogawa, Kasuya-gun (JP); Takashi Kitada, Ogoori-shi (JP); Hiroaki Sakai, Fukuoka-shi (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/116,263

(22) Filed: Apr. 28, 2005

(30) Foreign Application Priority Data
Apr. 28, 2004 (JP) 2004-133129

(51) Int. Cl. G06F 17/00

(52) U.S. Cl. 715/500; 709/203

(57) ABSTRACT

It is an object to provide an electronic paper display system capable of communicating in non-contact with an electronic paper by transfer apparatus and managing information by use of an electronic paper high in illegibility and portability as a medium of information display. An electronic paper display system that communication is made with display apparatus 2 having an electronic paper and wireless tag from transfer apparatus 1 capable of accessing a PC or a network, to perform a personal identification, based on which display information is transferred. Meanwhile, by transfer apparatuses 1 arranged in plurality in a space, the electronic paper is detected to manage information.

### SUMMARY OF THE INVENTION

1. Field of the Invention

The present invention relates to an electronic paper display system for generating and managing information by utilization of an electronic paper high in illegibility/portability and easy to manage information.

2. Description of the Related Art

Conventionally, there are those of a form for personal use that, when to look electronic information by the paper output high in illegibility and portability, the information is instructed for printing from a personal computer (hereinafter, abbreviated as PC) to a PC or to a printer connected to a network to thereby form an image on a paper or an electronic paper as a display device by means of the printer (see JP-A-2003-333001, for example).

Meanwhile, where to personally use the information existing in an image form on a paper, there are those of a form for copying by the copier or changing a scanner readout into electronic information so that it can be paper-outputted from a printer. Meanwhile, the data-display-functioning wireless tags include those representing the basic structure of an integral-form wireless tag having a display function for the purpose of use in a physical distribution management system (see JP-A-2002-236891, for example).

Meanwhile, there are those of a form utilizing information by connecting a portable notebook personal computer to a network system through a wireless LAN.

However, in the above example that is to output information on a paper from the conventional printer, it is thought that a 25% portion of the output results in garbage on the same day thus having a problem of resource wasting.

Meanwhile, the security management, of a paper, electronic paper or an information medium used on a notebook personal computer, is relied upon the user of information handling the paper or personal computer. Thus, there is a problem that information is to be managed insifficient.

### SUMMARY OF THE INVENTION

The present invention is to solve the foregoing problem, and it is an object thereof to provide an electronic paper display system capable of managing information using an electronic paper as an information display medium.

An electronic paper display system in the present invention uses an electronic paper capable of holding a display state in a power-free state and displaying an image by application of magnetism or electric field. Furthermore, it has a display apparatus mounted with a wireless tag function, communication means for receiving an electromagnetic wave from a transfer apparatus, and means for producing an image based on received information and recording an image to the electronic paper, incorporating a control circuit for controlling the operation, and a transfer apparatus having an antenna and control circuit for wirelessly transmitting information with the display apparatus and incorporating an interface circuit for connection to a personal computer. Thus, information transmission is made possible in non-contact with the display apparatus.

In the electronic paper display system of the invention, the transfer apparatus communicates in non-contact with the display apparatus, to detect an electronic paper and a display apparatus. By recognizing display-side personal identification information according to an information program, various data processes and event operations are carried out based on the personal identification information according to a previously set/registered information and process procedure. By sending image information and operation instructions to an arbitrary transfer apparatus, control/management is possible for display on a desired display apparatus and electronic paper. Furthermore, by arranging transfer apparatuses in plurality in a space, the electronic paper and display apparatus can be detected to enable information management.

### BRIEF DESCRIPTION OF THE DRAWINGS

FIG. 1 is an arrangement diagram of an electronic paper display system in embodiment 1 of the present invention.

FIG. 2 is an arrangement diagram of an electronic paper display system in embodiment 2 of the invention.

FIG. 3 is an interior block diagram of a transfer apparatus in embodiment 1 of the invention.

FIG. 4 is an interior block diagram of a display apparatus in embodiment 1 of the invention.

FIG. 5(a) is a sectional view of an electronic paper in embodiment 1 of the invention, and FIG. 5(b) is a plan view of the electronic paper in embodiment 1 of the invention.

FIG. 6 is a sectional view showing an image write operation to the electronic paper in embodiment 1 of the invention.

FIG. 7(a) is a transition diagram of an information program in embodiment 1 of the invention, and FIG. 7(b) a flowchart showing an operation outline in embodiment 1 of the invention.

FIG. 8 is an interior block diagram of a transfer apparatus in embodiment 2 of the invention.

FIG. 9 is an interior block diagram of a display apparatus in embodiment 2 of the invention.

FIG. 10 (a) is a sectional view of an electronic paper in embodiment 3 of the invention, and FIG. 10(b) is a structural view of a recording surface in embodiment 3 of the invention.

FIG. 11 is an interior diagram of a display apparatus of an electronic paper display system in embodiment 4 of the invention.

FIG. 12 (a) is a sectional view of an electronic paper in embodiment 4 of the invention, and FIG. 12(b) is a structural view of a recording section in embodiment 4 of the invention, and FIG. 12(c) a schematic view of a pixel drive circuit in embodiment 4 of the invention.

FIG. 13(a) is a structural view of an electronic paper in embodiment 9 of the invention, and FIG. 13(b) is a sectional view of the electronic paper in embodiment 9 of the invention.

FIG. 14 is a figure of an information management table in embodiment 2 of the invention.

FIG. 15 is a figure of an information management table in embodiment 2 of the invention.

FIG. 16 is a figure of a display-apparatus management table in embodiment 10 of the invention.

FIG. 17 (a) is a structural view of a recording head in embodiment 1 of the invention, and FIG. 17(b) is a sectional view of the recording head in embodiment 1 of the invention.

FIG. 18 is an outline view of an antenna in embodiment 13 of the invention.

### DESCRIPTION OF THE PREFERRED EMBODIMENTS

With reference to the drawings, explanations will be made on the best mode for carrying out a display system of an electronic paper according to the present invention which is given a function readable as a paper and excellent in information management. It is noted that the embodiments described below are to be combined in use.

### Embodiment 1

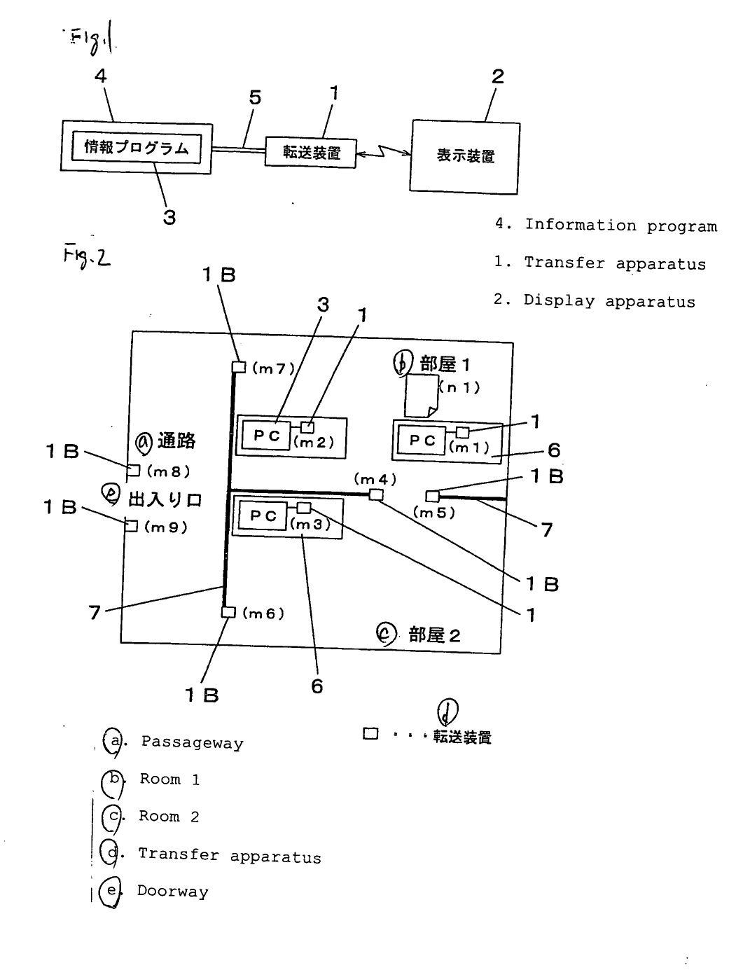

FIG. 1 is an arrangement diagram of an electronic paper display system in embodiment 1 of the invention. In FIG. 1, 1 is a transfer apparatus, 2 is display apparatus, 4 is PC for installing an information program 3 thereon, and 5 is a cable. Transfer apparatus 1 is connected to PC by cable 5. Meanwhile, transfer apparatus 1 and display apparatus 2 are wirelessly connected with each other. Incidentally, PC 4 and transfer apparatus 1 in this embodiment are connected by the cable but can be connected wirelessly by such means as a wireless LAN.

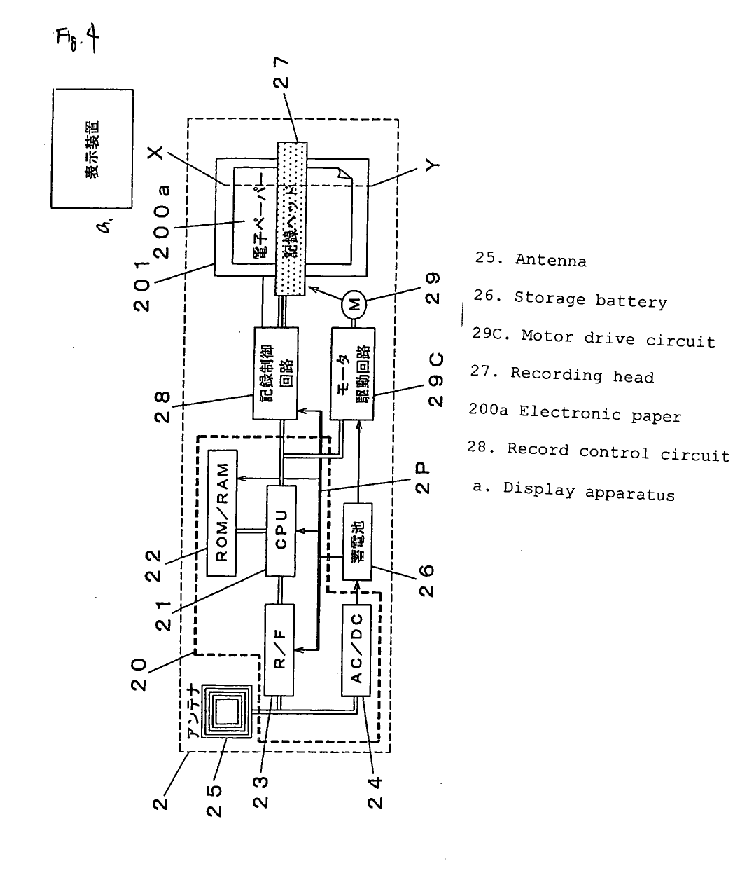

The present system basically enables to output the information prepared in PC to predetermined display apparatus 2 by way of transfer apparatus 1. With reference to FIGS. 3 to 7, explanation is now made in detail on the operation of the basic system shown in FIG. 1.

FIG. 3 is an interior block diagram of the transfer apparatus in embodiment 1 of the invention, wherein 11 is a CPU, 12 is a ROM/RAM as storage means, 13a is an PC IF to PC 4, 14 is an antenna drive circuit, 15a is an antenna, and 16 is a storage battery.

CPU 11 is to control the operation of transfer apparatus 1 according to the program installed on ROM/RAM 12. Transfer apparatus 1 has PC IF 13a connected to PC 4 by a cable under the specification of USB2.0. Accordingly, transfer apparatus 1 does not require a power-source circuit. Power can be supplied through the cable connected to PC 4 and stored in the storage battery 16 so that driving can be effected on the power. 1P is a direct-current power outputted from the storage battery 16, which is to be supplied to various circuit blocks. Incidentally, although this embodiment omitted the use of a power-source circuit, power source means may be configured having an AC power-source circuit or a battery. Incidentally, although transfer apparatus 1 shown in FIG. 1 was described connected to PC 4 through a cable because of taking an example of PC 4 as a general-purpose information processing apparatus, it can be realized by an exclusive apparatus configured with transfer apparatus 1 and PC 4 integrally.

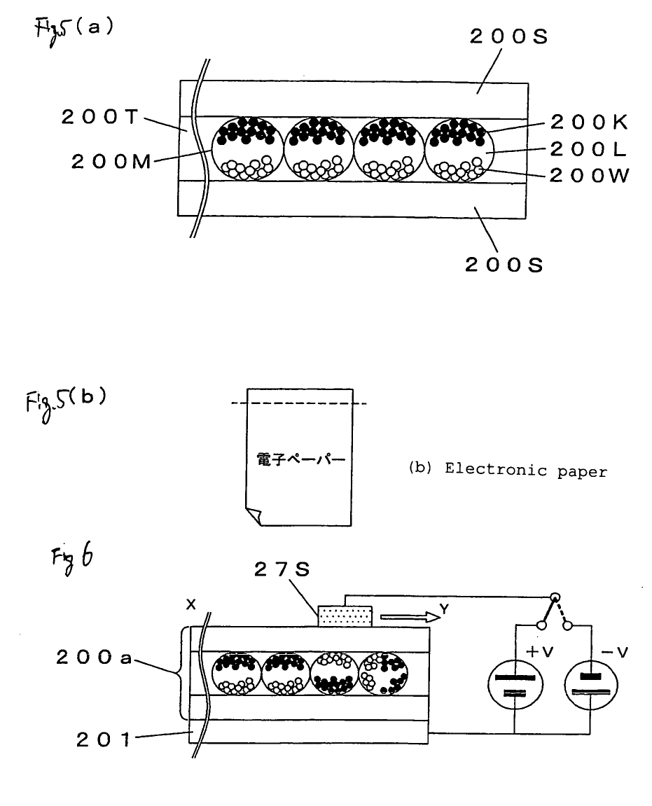

FIG. 4 is an interior block diagram of the display apparatus in embodiment 1 of the invention. 21 is a CPU for controlling the operation of display apparatus 2, 22 is a ROM/RAM for holding/recording a control program or data, 23 is an RF converter circuit for extracting a signal out of a radio frequency received, 24 is an AC/DC converter circuit for extracting an electric energy from an electromagnetic wave received at the antenna 25 and converting it into a direct-current power, 25 is a transmission/reception antenna for communication with transfer apparatus 1, 26 is a storage battery for storing a direct-current power generated by the AC/DC converter circuit 24, 27 is a line-type recording head having a plurality of pixel electrodes for applying an electric field to an electronic paper 200a in a state contacted with the electronic paper 200a and sandwiching same with a common electrode 201, 28 is a record control circuit for applying a voltage to the pixel electrode of the recording head 27, 29 is a drive motor for moving the recording head 27 relative to the electronic paper 200a in a transport mechanism, not shown, 29C is a motor drive circuit for controlling the operation of the drive motor 29.

Here, the electronic paper 200a is to be attached to and detached from the display device 2 by means of a mechanism, not shown. The control of attachment and detachment is under management according to the information program 3. Meanwhile, the power of the storage battery 26 is used in the operation of recording to the electronic paper 200a.

The section surrounded by broken line in FIG. 4 is a circuit configuration similar to that of the constituent elements in realizing a wireless tag, which can be made as an IC extremely small in size. However, this embodiment, because mounting a write circuit to the electronic paper 200a to consume power by far greater as compared to that of a wireless tag, is greatly different in basic specification as to the power-receiving antenna 25, the AC/DC converter circuit 24 for converting the energy and the storage battery 26. For example, the electromagnetic wave at a frequency of 1 MHz is efficiently received to extract at the antenna 25 a low AC voltage to be converted by boost into a DC voltage of 25V. The power is stored on a two-layered electric capacitor that is utilized as a storage battery 26. Incidentally, the storage battery 26 may incorporate therein a control circuit for extracting a stable voltage.

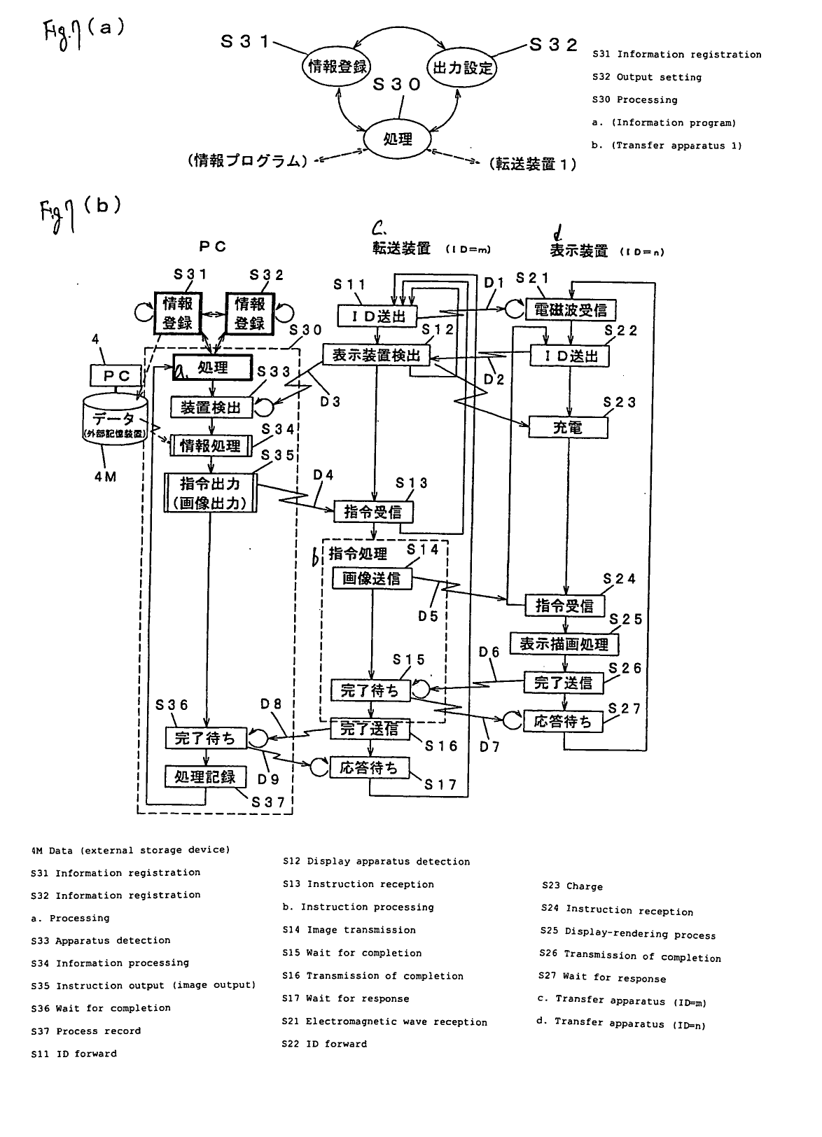

FIG. 5(a) is a sectional view of the electronic paper in embodiment 1 of the invention, showing a structure that the electronic paper 200a is made by an electrophoretic-schemed electronic paper in the prior art. FIG. 5(b) is a plan view of the electronic paper in embodiment 1 of the invention. 200M is a microcapsule having the function of electronic ink. 200S are light-transmissive sheets sandwiching the microcapsules 200M. 200T is a non-conductive binder for bonding the microcapsules 200M on the sheet 200S.

Here, the microcapsule 200M is charged with a plurality of particles and a suspension fluid dyed. The particles have an optical reflective characteristics and contrasted electrophoretic natures. For example, 200K uses a black particle charged + (positive) while 200W a white particle charged − (negative). 200L can be comprised of a transparent suspension fluid. Incidentally, although the electronic paper in this embodiment had both surfaces made by transparent sheets 200S, one surface may be a non-transmissive sheet or a metal-deposited sheet.

FIG. 6 is a sectional view showing the operation of image write to the electronic paper in embodiment 1 of the invention. By switching the polarity of the voltage applied to between one of pixel electrodes 27S of the record head 27 arranging thereon pixel electrodes in a line form by means of the record control circuit 28, the charged particles 200K and 200W are placed in electrophresis at within the microcapsule 200M. This makes it possible to write a line-formed display image to the record head 27 at the underneath thereof. Furthermore, the record head 27 is moved in a Y-direction to thereby record the next line. Due to this, image write can be effected over the entire surface of the electronic paper 200a.

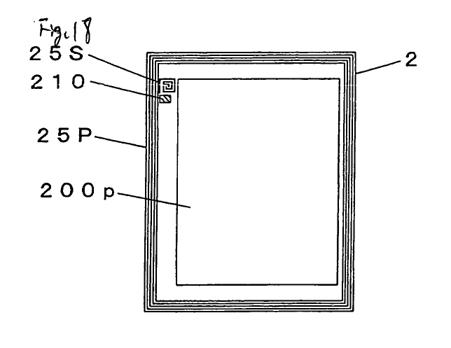

FIG. 17(a) is a structural view of the record head in embodiment 1 of the invention, wherein pixel electrodes 27S are arranged at an equal interval in a line. The pixel electrodes 27S are connected to the record control circuit 28 by way of lines, not shown. FIG. 17(b) is a sectional view of the record head in embodiment 1 of the invention, wherein the pixel electrode 27S is present in a surface on the side to be contacted with the electronic paper.

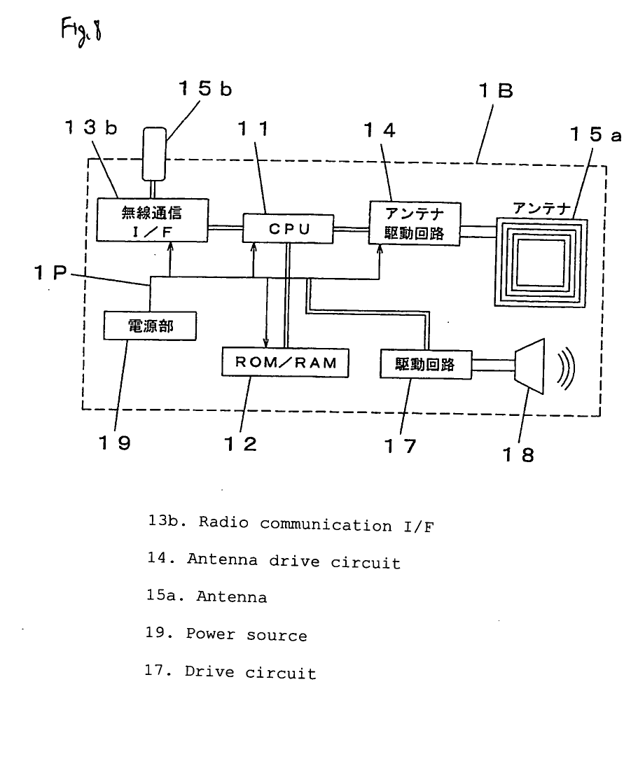

FIG. 7(a) is an information-program transition diagram in embodiment 1 of the invention, which is constituted by the blocks of image registration, output setting and process operation. Usually, the information program is in waiting for an event occurrence. Upon the occurrence of an event, the operation block is to be executed.

FIG. 7(b) is a flowchart showing an operation overview in embodiment 1 of the invention. Referring to this figure, the operation is explained in detail. The user, who entered an information register mode through a menu screen, not shown, of the information program, is allowed to proceed to step S31 where he/she registers, to PC 4, display information, such as of images and characters, user's individual attribute information, discrete information for managing display apparatus 2, etc. that are to be displayed on display apparatus 2. Here, display information includes those of image information made into data by a scanner, and document information constituted by a text, a figure, a graph or a photographic picture prepared by application software. Meanwhile, user includes a use form of a plurality of persons, such as those who are on the side to view information or those who are on the side to manage/provide information. For this reason, in order to identify and manage a plurality of users, it is possible to provide diversified conveniences by managing various pieces of personal information, such as names, in-company position and authority, age, passwords for security management, and so on.

Then, when an output setting mode is entered by the user on PC 4 through a menu screen, not shown, of the information program 3, the process proceeds to step S32. At the output setting step S32, the user is to make various output settings as to the information to be displayed. For example, desirable setting is made on the information to be displayed, user designation, display apparatus choice, transfer apparatus designation, display term and so on. Those pieces of output setting information are recorded and stored in PC 4 or in an external storage device 4M connected to PC 4.

Here, the information to be displayed can be prepared by processing the information registered by a previously prepared process procedure according to the personal information of the user possessing the display device or the user authenticated on PC 4. For example, various information processes and applications are available, e.g. displaying only a part of registered information, merging a plurality of pieces of information and delimiting a display time.

The operation is now explained on an example with an output setting for a case of viewing the registered information of material 1, not shown, at display apparatus ID=n by way of transfer apparatus ID=m.

When connected to PC 4 and supplied with power, transfer apparatus 1 at step S11 regularly outputs the information D1 including a discrete ID, as a predetermined signal of electromagnetic wave, through the antenna 15a. Repeated operation is continued for display apparatus detection at steps S11 and S12 that is also for ID forwarding and electromagnetic wave supply. Here, in case of a detection at step S21 by a reception power that the user carrying display apparatus 2 comes near transfer apparatus 1 and lies at a location within a distance the electromagnetic wave is to be received, display apparatus 2 receives an energy of the electromagnetic wave as a power and proceeds to step S22 where it forwards to transfer apparatus 1 the information D2 including a discrete ID possessed by display apparatus 2. Transfer apparatus 1 transmits, to PC 4, information D3 that ID(m) of transfer apparatus 1 is included in the discrete ID of display apparatus 2 detected at the step S12. Display apparatus 2, after forwarded the ID, proceeds to step S23 where it receives an electromagnetic wave from transfer apparatus 1 and charge energy to the storage battery 26. Subsequently, until receiving an instruction from transfer apparatus 1 at step S24, the process waits while repeating the ID forward at step S22 and the charge operation at step S23.

PC 4, at step S33, is sent a detection of display apparatus 2 and ID thereof from transfer apparatus 1 and detects it as an apparatus that output designation is made from the discrete information previously set for output at the step S32. Furthermore, when confirming that an output condition designated is satisfied, the process proceeds to step S34 where information processing is made according to the output setting information set at the step S32. Here, because the output setting records a setting for outputting material 1 to display apparatus ID=n, PC 4 processes the information of material 1 stored in PC 4 or in the external storage apparatus 4M of PC4 into image information in a size to be displayed as an electronic paper, then proceeding to step S35. At step S35, an image output instruction is sent as information D4 to transfer apparatus 1 of ID=m detected as display apparatus 2 of ID=n. Incidentally, where the output setting recorded does not have any setting to instruct, the process moves to an event-wait state shown in FIG. 7(a).

Transfer apparatus 1 at step S13, when receiving instruction information D4 from PC 4, processes the instruction. Transfer apparatus 1 detected and grasped as to whether or not display-recording apparatus 2 of ID=n lies within a range receivable by transfer apparatus 1. When within the range, the process proceeds to step S14 in order for instruction processing. Meanwhile, when display apparatus 2 designated is not detected, the process waits until achieving a detection while repeating the steps of from S11 to S12. Because the instruction herein is to output the image of material 1 to display apparatus 2 of ID=n, the image information of material 1 is transmitted as information D5 together with the instruction information representative of an output to display apparatus 2 of ID=n through the antenna 15a.

Display apparatus 2 at step S24, when recognized a fact the image output instruction is for itself, stores the image information of material 1 sent together to the ROM/RAM 22. Display apparatus 2 at step S25 performs a display-rendering process of image depending upon the received image information, thus writing the image to the electronic paper 200a line by line. After completing the writing of all the information received, the process proceeds to step S26 where a signal D6 of instruction process completion is sent together with instruction information and ID information to transfer apparatus 1.

Transfer apparatus 1 at step S15, after receiving an instruction completion from display device 2, outputs a response signal through the antenna 15a, and then moves to step S16. Furthermore, at step S16, it transmits instruction complete information D8 at I/F 13a to PC 4, and the process moves to step S17 where to wait for a response from PC 4.

PC 4, after outputting an instruction at step S35, moves to step S36 where waiting for instruction complete information D8 from transfer apparatus. When confirming instruction complete information D8, a response signal D9 is transmitted to transfer apparatus 1, and the process moves to step S37. At the step S37, PC 4 records the fact of completing the processes in series as a history in a not-shown storage means of within PC 4 or in an external storage device 4M connected to PC 4.

Transfer apparatus 1, after receiving and confirming at the step S17 the response signal D9 from PC 4, returns to the former step S11.

According to this structure, in the electronic paper display system of the invention, transfer apparatus 1 communicates in non-contact with display apparatus 2, to detect a display apparatus 2. By recognizing the personal identification information on the display side by means of the information program 3, various data processes can be effected based on the personal identification information according to previously set/registered information and process procedure. By forwarding image information and an operation instruction to an arbitrary transfer apparatus 1, display can be controlled/managed onto a desired display device 2. Accordingly, after outputting setting, desired information can be displayed on arbitrary display information by merely placing display apparatus 2 close to transfer apparatus 2. This makes it possible to provide a printing solution environment nonexistent in the conventional.

Furthermore, the electronic paper 200a is in a simple structure merely sandwiching a microcapsule as an electronic ink between sheets without having write electrodes and circuits, thus being made inexpensive, flexible and light in weight. Besides, because it can be removed from display apparatus 2, display information can be viewed just like a paper without difficulty. Meanwhile, the electronic paper can be used for the purpose of diminishing the paper resource uselessly consumed in trial output of preparation documents because repeated writing and erasure are possible.

Incidentally, the present embodiment described, as information processing, the example of processing from information material 1 into image information in a size for display onto an electronic paper. However, by making diversified information processes e.g. a processing as image information to display only a part of material 1 from user's attribute, and a processing as image information by adding another piece of information to material 1, it is possible to realize various conveniences, such as calling attentions and reconfirmation to the user and increased efficiency and advertisement effect due to information summarization.

### Embodiment 2

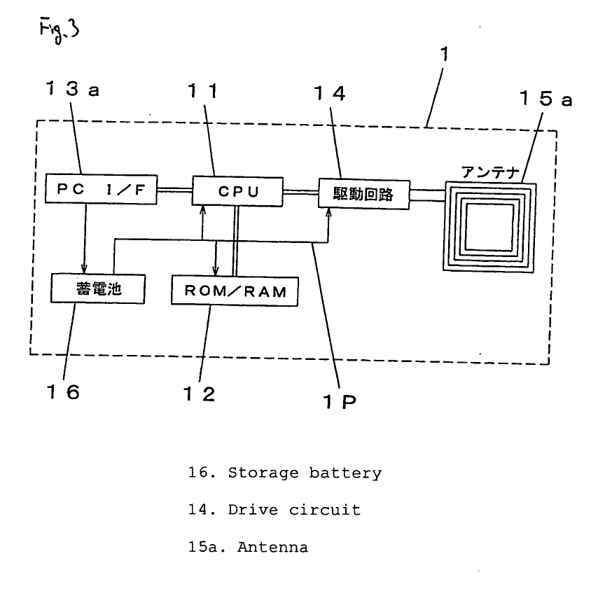

FIG. 2 is an arrangement diagram of an electronic paper display system in embodiment 2 of the invention. In FIG. 2, the same constituent elements as those of FIGS. 1 and 3 to 7(b) are attached with the same references, to omit the explanations thereof.

FIG. 2 shows a complex system arrangement using an electronic paper display system arranging a plurality of transfer apparatuses 1 and PCs 4 within a room. In FIG. 2, 6 is a table for resting the PC and transfer apparatus 1 thereon, 7 is a wall partitioning the room, 1B is another form of transfer apparatus 1 which is a connection apparatus having a function of wireless connection to a network, thus constituting an electronic paper display system.

PC 4 connected with transfer apparatus 1 is installed thereon with an information program 3. Note that one information program 3 serves as a master administrating the overall whereas the others are to operate under the dominance thereof by taking an association with the information program 3 set up on the master. Those associative operations are to be executed in operation block S30 for the processing of FIG. 7(a).

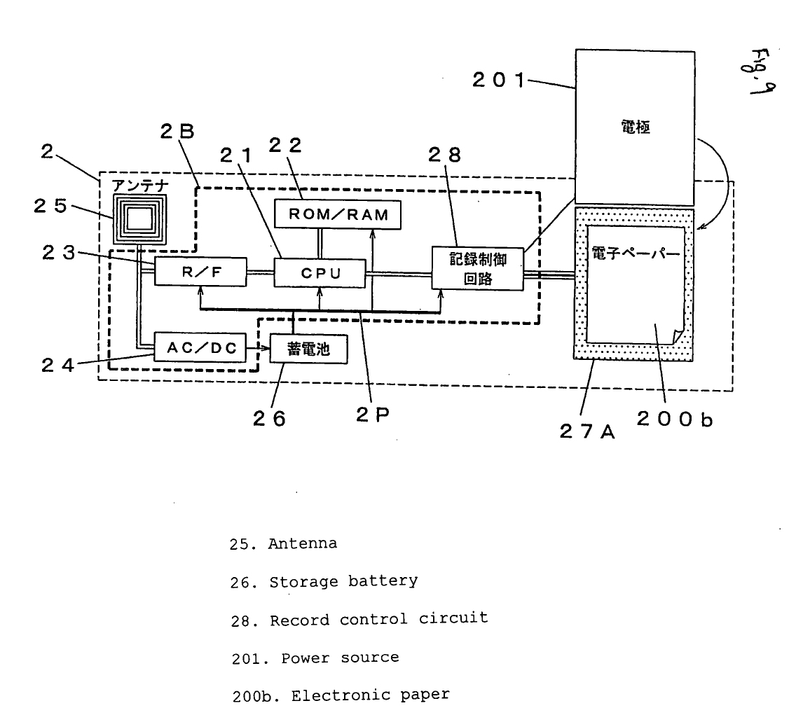

FIG. 8 is a block diagram of the transfer apparatus in embodiment 2 of the invention. In FIG. 8, the same constituent elements as those of FIG. 3 use the same references, to omit the explanations thereof. Transfer apparatus 1B are nearly in the same configuration as transfer apparatus 1. The difference lies in that the interface circuit to the PC is a wireless communication interface circuit 13b compatible with wireless communication, such as of Bluetooth or Wireless LAN, as known arts, wherein there is provided a communication antenna 15b for the purpose thereof and further a buzzer 18 and its drive circuit 17 for issuing alert sound.

Transfer apparatus 1B is in a state always connected to the network, which are under management of the information program 3 set up on the master for management of the system overall. For this reason, discrete ID information is set up in the ROM/RAM 12 as a storage device built in the transfer apparatus. This ID enables for the information program to identify the transfer apparatuses in plurality.

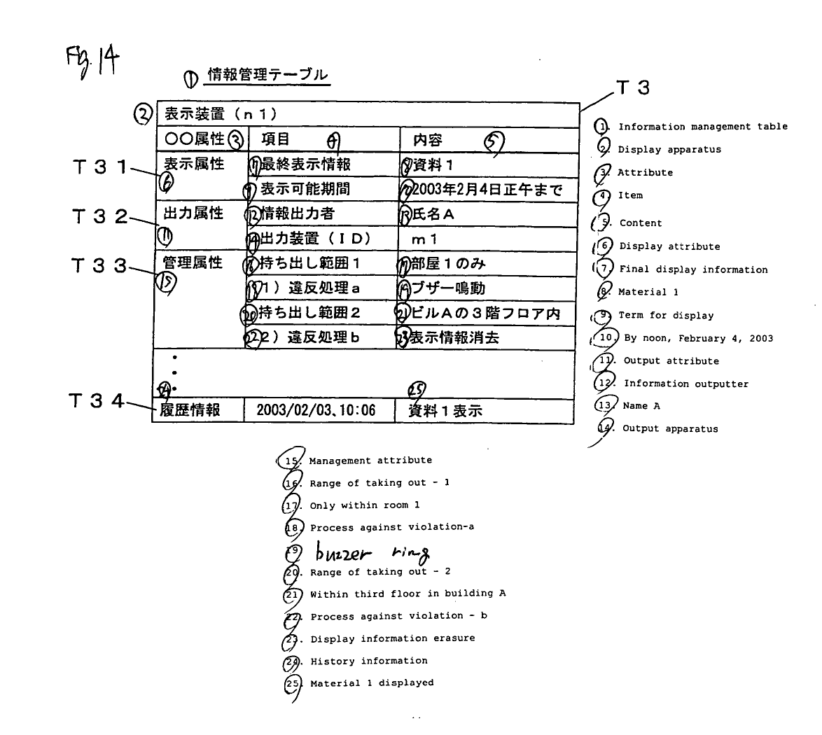

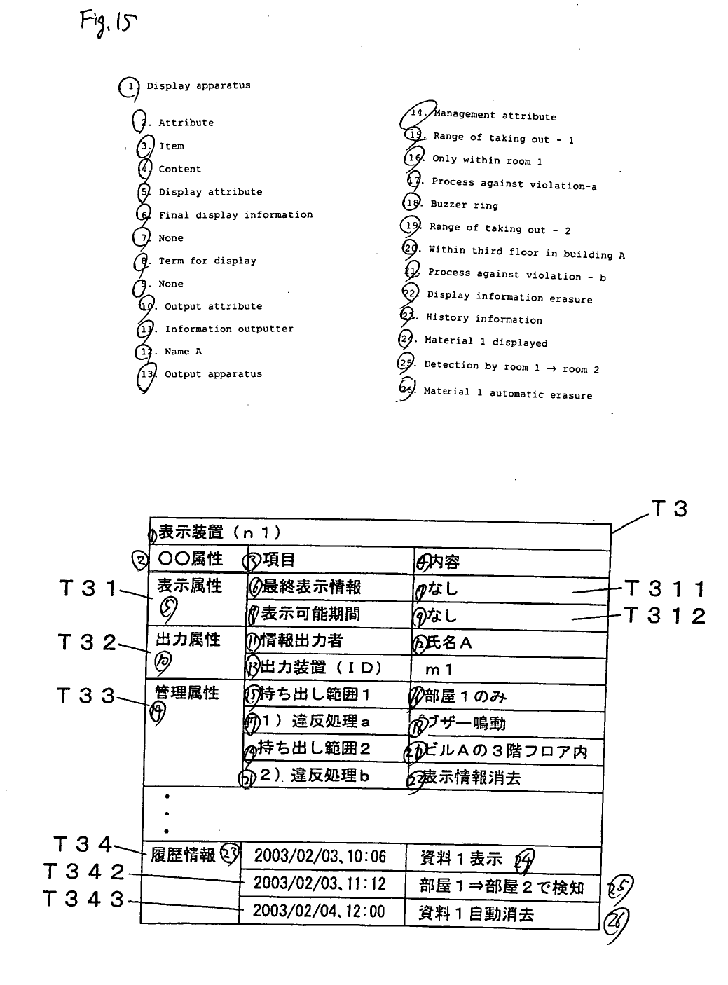

FIGS. 14 and 15 are figures of information management tables in embodiment 2 of the invention, which are tables representing an embodiment as to the information management table describing management information, in display apparatus 2 (ID=n1) where executing an information processing according to the information program 3. Information program 3 is provided with information management tables T3 respectively for display apparatuses, in order for information management. This embodiment comprises a plurality of attributes, i.e. display attribute T31, output attribute T32, management attribute T33 and history attribute T34.

Here, explanation is made on the content of information management table T3, as an example displaying in the last time the content of material 1 on display apparatus 2 (n1). Display attribute T31 is constituted with an item of final display information representative of the content currently displayed on display apparatus 2 (n1), and an item of displayable term for managing a term in which the information is to be displayed. Here, material 1 is being displayed wherein recorded is information that display is possible up to the noon, Feb. 4, 2003.

Output attribute T32 is constituted with an item representative of a person who output-processed the relevant information, and an item recording output apparatus ID information representative of which one of the transfer apparatus output was made from. This example records that a person of name A outputted the relevant information from transfer apparatus (ID=m1).

Management information T33 records a scope the display information can be taken out, and a measure against the violation thereof. For example, the scope of bringing out is established by an information manager in accordance with information content. Furthermore, this can be automatically decided by a combination of information management level setting and user's personal attribute, according to a program. History information T34 records a history of the event information occurring on display apparatus 2 (n1) in an amount of predetermined period of time (e.g. leaving the record limited up to 5 years ago). In FIG. 14, there is recorded the fact that material 1 has been displayed at 10:06, Feb. 3, 2003.

Referring to FIGS. 2, 7(b), 14 and 15, explanation is made in detail on the operation of the complex system arrangement shown in FIG. 2. In the case that display apparatus (n1) outputted material 1 is taken out at 11:12, Feb. 3, 2003 into room 2 by a person of name A, this fact is detected by transfer apparatus 1B (ID=m4) provided at a doorway connecting between room 1 and room 2 and transmitted to the information program 3 of the master. The information program confirms the content of an information management table registered, from the detected ID of display apparatus. Here, alert sound is issued according to the management information by instructing transfer apparatus 1B (ID=m4) to ring a buzzer as set up as a violation measure-a. Simultaneously, this event is additionally recorded as history information data to history information data T342.

Incidentally, a plurality of transfer apparatuses 1B are set up at the doorway so as to positively detect display apparatus 2 in accordance with the size thereof. Accordingly, the user of display apparatus 2 (n2) is aware of by alert sound with a result that he/she is prevented from taking the display apparatus 2 back to room 1 and bringing material 1 prohibited by information management to room 2.

Furthermore, after the user has viewed and utilized material 1, when it becomes 12:00, Feb. 4, 2003 an instruction for erasing display information is sent from the information program 3 recognized a displayable term to transfer apparatus 1B recognizing display apparatus (n1) by way of information program 3 of PC 4 connected with transfer apparatus 1B. After confirming a completion of erase operation at the display apparatus according to the response signal, cleared are final display information data T311 and displayable term data T312 of display attribute. Furthermore, the event automatically erased is additionally recorded as history information data to history information data T343 (information management table in FIG. 15, for the above)

According to this structure, in the electronic paper display system of the invention, transfer apparatus 1 communicates in non-contact with display apparatus 2, to detect display apparatus 2 and recognize it based on display-side personal identification information according to information program 3. By set/recorded information and process procedure, it is possible to manage the location of display apparatus 2, to issue an alert to the user against taking-out and control and manage the display information. Accordingly, a broad use environment can be architected that electronic paper and display information management can be systematically utilized by the electronic paper display system. Incidentally, in this embodiment, display attribute T31, output attribute T32, management attribute T33 and history information T34 were provided in the information management table. Instead, other attributes and data for management information may be provided therein.

### Embodiment 3

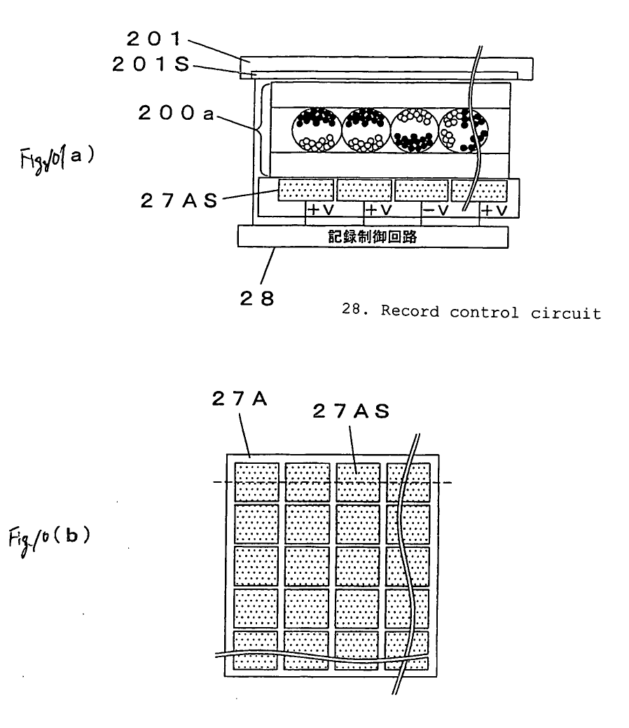

FIG. 9 is an interior block diagram of a display apparatus in embodiment 3 of the invention. In FIG. 9, the same constituent elements as those of FIG. 4 are attached with the same references, to omit the explanations thereof. In display device 2 in FIG. 9, write to the electronic paper is by being sandwiched between two surfaces thereby enabling a recording by surface-based writing. In FIG. 9, 27A connected to a record control circuit 28 is a recording surface while 201 is an electrode sheet. Those constitute a recording section to the electronic paper 200a. Incidentally, the section 2B surrounded by broken line is a circuit of other than the display section, which can be made as one-chip IC. Accordingly, utilization is by placing the electronic paper 200a on the recording surface 27A of display apparatus 2 in a state sandwiched by a light-transmissive electrode sheet 201 arranging a transparent electrode over the entire surface.

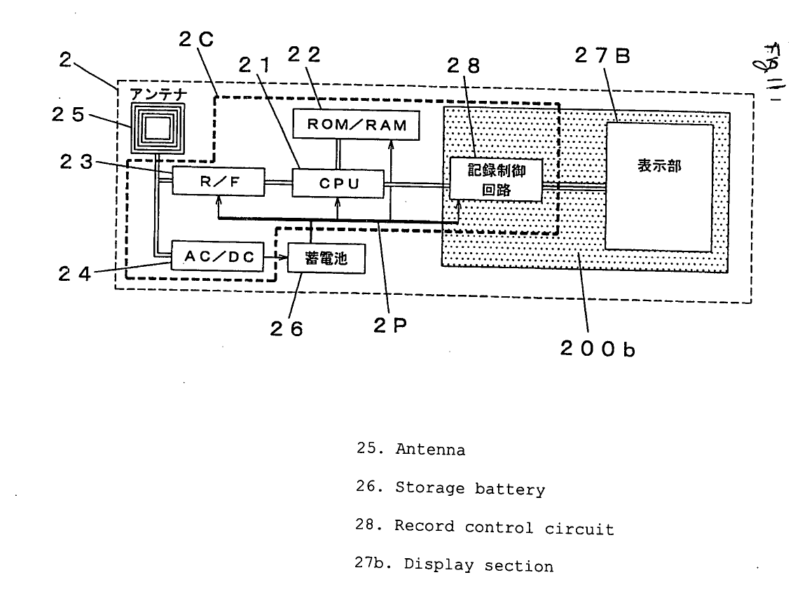

FIG. 10(a) is a sectional view of an electronic paper in embodiment 3 of the invention, which is a sectional view explaining the write operation in this time. FIG. 10(b) is a structural view of a recording surface in embodiment 3 of the invention. A plurality of pixel electrodes 27AS are arranged on the recording surface 27A, and connected to a recording control circuit 28 by a line, not shown. An electrode 201S exists on a side surface of the electronic sheet 201 to be contacted with an electronic paper. By applying an arbitrary voltage with the foregoing electrode 27AS, an electric field is caused to enable writing to the electronic paper 200a.

According to this structure, display apparatus 2 of the electronic paper display system of the invention eliminates the necessity of such a motor or drive mechanism as used in FIG. 4 in writing to the electronic paper. Furthermore, because information can be viewed and carried while sandwiching same by a transparent electrode sheet 201, improved is the convenience that the electronic paper is free from being stripped off. Similarly to this, it is a generally frequent practice to use a form of carrying a document by being sandwiched in a stationery clear-file. In addition to the conventional convenience, because rewrite is possible for electronic paper display, the paper to be carried can be reduced in amount.

### Embodiment 4

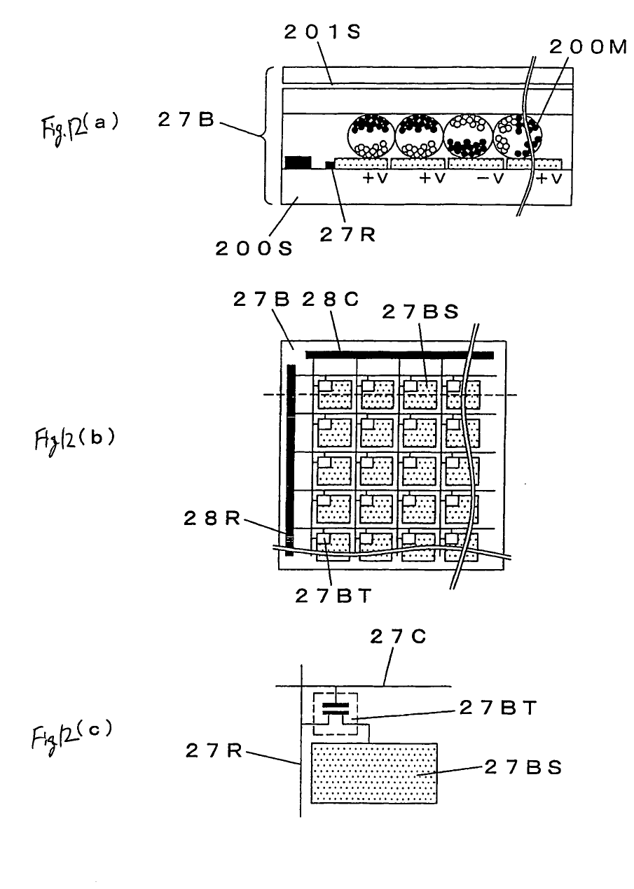

FIG. 11 is an interior block diagram of a display apparatus of an electronic paper display system in embodiment 4 of the invention. In FIG. 11, the same constituent elements as those of FIG. 4 are attached with the same references, to omit the explanations thereof. The display apparatus in FIG. 11 is arranged for writing, in a surface to the electronic paper 200b, constituting an electronic paper 200b by means of a recording control circuit 28 and a display section 27B. Incidentally, the section 2C surrounded by broken line is a circuit of other than the display section, which can be made as one-chip IC. However, a switch-element drive circuit in the display section can be configured separately. Here, the electronic paper 200b is in a structure that a microcapsule 200M is sandwiched between an electrode 201 surface and a surface arranging a pixel electrode 27BS, thus being in an integral form with the display apparatus 2.

FIG. 12(a) is a sectional view of the electronic paper in embodiment 4 of the invention, which is a sectional view explaining a write operation at this time. FIG. 12(b) is a structural view of the recording section in embodiment 4 of the invention. FIG. 12(c) is a schematic view of a pixel drive circuit in embodiment 4 of the invention.

In the display section 27B, 27BS is a pixel electrode, 27BT is a switching element, 28R is a horizontal drive circuit and 28C is a vertical drive circuit. A plurality of pixel electrodes 27BS are arranged in the display section 27B. The pixel electrode 27BS has a switching element on each pixel thereof. As shown in FIG. 12(c), the switching element 27BT has gate and source electrodes respectively connected to a gate line 27C and a source line 27R as horizontal and vertical lines connected to the drive circuits 28R and 28C in this embodiment. This makes it possible to individually drive the pixel electrodes 27BS connected to the drain electrodes of the switching elements 27BT. Incidentally, although the drive circuits 28R and 28C are isolated from the recording control circuit 28, those may be incorporated in the section 2C in an integral form.

According to this structure, in the display apparatus 2 in the electronic paper display system of the invention, because the electrode for electric-field application to the microcapsule 200M can be put in close contact during writing to the electric paper, the application voltage for writing can be reduced. Furthermore, because the pixel electrode 27BS and the color-based microcapsule provided in multi-colors can be matched in a preparation stage of an electronic paper, color display can be coped with. Meanwhile, in case a plurality of display apparatuses are arranged in a section always communicatable with a transfer apparatus, it is possible to supply, in a particular time, information suited for a purpose to particular display apparatuses classified based on purposes. Namely, conveniences can be provided in many fields, e.g. of work order sheets, operation manuals and hospital medical chart. Incidentally, although this embodiment provided one switching element 27BT on one pixel electrode 27BS, an active-matrix drive structure may be provided by providing a power-source line and a plurality of switching elements.

### Embodiment 5

Although the electronic paper 200a as a display device of display apparatus 2 in FIG. 4 was structurally attachable/detachable to/from the display apparatus 2 and provided only one, a plurality of electronic papers 200a can be structurally removably attached on a individual basis. Furthermore, it is possible to provide a plurality of electronic papers 200a different in size to be removably attached on an individual basis. Meanwhile, the electronic paper 200a can be unremovably fixed on the display apparatus 2 or the information storage means can be incorporated in the display apparatus.

According to this structure, in the display apparatus 2 of the electronic paper display system of the invention, it is possible to display much more information at one time and to easily carry only the necessary information. Furthermore, where storage means is incorporated, display information can be received and stored together with management information. Because information writing, erasure and display management can be carried out only on display apparatus 2, much more information can be displayed singly.

### Embodiment 6

Although display apparatus 2 in FIG. 4 is for writing to the electronic paper 200a by moving the record head 27 relative thereto, the electronic paper 200a can be transported by fixing the record head 27 as in the thermal printer. This structure can make display apparatus 2 of the electronic paper display system of the invention smaller in size.

### Embodiment 7

Although not shown, display function means such as a liquid-crystal display can be provided though not provided in the transfer apparatus shown in FIG. 4 or 8. This structure can provide much more information and instructions for alert and cautions to the user in the transfer apparatus of the electronic paper display system of the invention, thus improving conveniences.

### Embodiment 8

Although the buzzer in FIG. 8 was provided on transfer apparatus 1B, it can be mounted on display apparatus 2. Meanwhile, besides the buzzer, it is possible to mount other means, e.g. vibrations or light flicker to be perceived by the user. Furthermore, alert can be provided by means of alert sound by the buzzer possessed by the PC or of display on a display screen. This structure can further improve user's perception as to alert.

### Embodiment 9

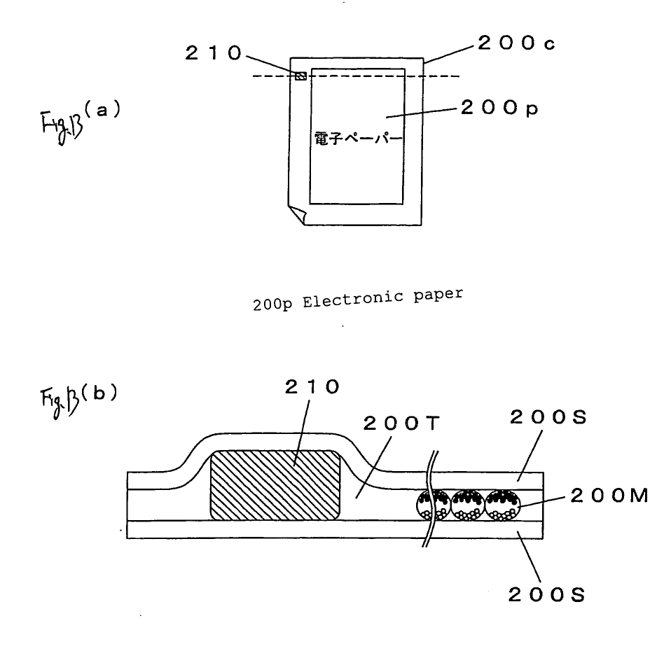

FIG. 13(a) is a structural view of an electronic paper in embodiment 9 of the invention. FIG. 13(b) is a sectional view of the electronic paper in embodiment 9 of the invention. In the electronic paper 200c, a wireless tag 210 is sandwiched between the outer side of a display section 200p including a microcapsule 200M and the sheet 200S, and bonded by a binder 200T similarly to the microcapsule 200M.

The wireless tag 210, known as an RF ID, is configured with similar circuit blocks to those of CPU 21, ROM/RAM 21, RF converter circuit 23, AC/DC converter circuit 24, antenna 25, storage battery 26, etc. shown in display apparatus 2. This is in a practical application in a size of nearly a sesame grain. The wireless tag 210 can be arranged to have direct wireless communication with transfer apparatus 1 or wireless communication with display apparatus 2.

According to this structure, even where the electronic paper is in a specification it can be removably attached on display apparatus 2, the electronic paper removed and its information can be managed without the attachment/detachment mechanism mounted on display apparatus 2 for the purpose of monitoring.

Incidentally, although this embodiment mounted one wireless tag, a plurality of wireless tags may be mounted correspondingly to different radio frequencies. Furthermore, although the wireless tag made by a semiconductor chip is incorporated herein, a circuit pattern of an organic semiconductor may be patterned over the sheet 200S. This structure can improve the simultaneous detection performance of a plurality of electronic papers, making it possible to provide an electronic paper even in thickness.

### Embodiment 10

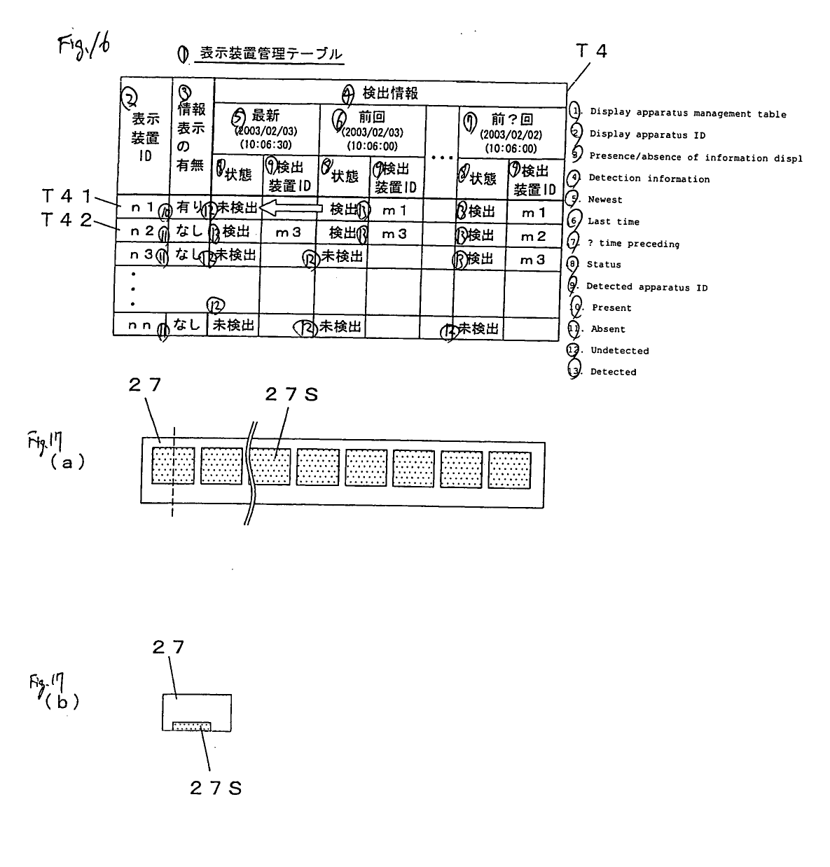

In the information program 3, the operation block S30 is allowed to have a display-apparatus management process of after performing an information display. FIG. 16 is a figure of a display-apparatus management table in embodiment 10 of the invention.

Display-apparatus management table T4 stores and manages, over a particular term, the presence or absence of information display, the state as to whether detected at a constant or non-constant time interval and the ID information of a detected transfer apparatus, for each ID of display apparatus.

Because the operation of information output setting was described in FIG. 7(b) in embodiment 1, explanation is now made on the operation of the information program 3 provided with a post-information-display process with reference to FIG. 7(b). In a state that the distance between the transfer apparatus and display apparatus 2 becomes longer than a wireless communicatable section or display apparatus 2 is put in a metal case or so and shielded of the radio waves, display apparatus 2 can no longer be detected from transfer apparatus 1. Transfer apparatus 1, at step S12 in display apparatus detection, transmits the fact of impossibility of detection, as information D3, to PC 4. PC 4, at step S33 in apparatus detection, updates at a constant time interval the information of display-apparatus management table as shown in FIG. 16, and proceeds to the next step.

At step S34 in information processing, display-apparatus management process is performed. Here, because there is a status change in display device (ID=n1) having display information from detectable status into non-detectable status, information program 3 prepares a buzzer-ring instruction output to the PC connected to transfer apparatus 1 (ID=m1) detected display apparatus (ID=n1) up to the last time. Subsequently, at step S35, a buzzer-ring instruction is outputted via a network to the PC connected to transfer apparatus 1 (ID=m1). The PC connected with transfer apparatus 1 (ID=m1), received the instruction, issues a buzzer sound.

This structure enables information management by notifying, by issuing an alert sound, the user on display apparatus 2 displaying the information requiring management to make the display apparatus stay within a perceivable section. Incidentally, although this embodiment issued a buzzer sound from the PC, a buzzer sound may be issued directly from transfer apparatus 1B instead from the PC where the apparatus detected is transfer apparatus 1b having a buzzer.

### Embodiment 11

Display apparatus 2 shown in FIGS. 4, 9 and 11 has a recording section to electronic paper whose circuit can be configured by an organic semiconductor. Particularly, the switching element 27BT shown in FIG. 12(b) desirably uses an organic field-effect transistor. For example, rendering is performed with conductive-polymer PEDOT (polyethylenedioxythiophene) by an inkjet scheme, to form a source, a drain and a gate. A conjugate-polymer semiconductor layer is formed to a film thickness of 30 nm or smaller on the source and drain by a spin-coat technique, on which a polymer insulator layer is formed to a film thickness of 500 nm by a spin-coat technique, to thereby form a gate thereon. Due to this, a top-gate structured TFT can be realized. This structure can reduce the thickness and weight of display apparatus 2 or electronic paper.

### Embodiment 12

The antenna mounted on transfer apparatus 1 or display apparatus 2 can be structured of an organic material. For example, the antenna is structured of a metal plate, a magnetic material or a conductor pattern. In order to prevent the unwanted radiation of electromagnetic field from the surface on which transfer apparatus 1 is placed on a table, a metal sheet such as of aluminum is used on one surface of the antenna, on which a magnetic material or a hybrid material an inorganic material of a magnetic or dielectric material is mixed with a polymeric organic material is layered by pressing or so, on which an antenna pattern is further formed of an organic material extremely low in resistance value and high in conductivity by an inkjet scheme, thereby forming a sheet-formed antenna. On the sheet-formed antenna, an IC chip incorporating a peripheral circuit is mounted in a manner contacted with an end of the antenna pattern, thus making up an apparatus. Incidentally, the foregoing metal plate for shield may be omitted on the antenna of display apparatus 2.

Where power transmission is implemented between the transfer apparatus and the display apparatus, electromagnetic induction can be utilized. However, the antenna, made by a coil for use on the PHS terminal and electronic shaver, generally has a power transmission efficiency of as low as nearly 20-30 percent. This is large in size because of using a coil increased in the number of turns wound over its ferrite core in order to increase its output voltage.

In this embodiment, organic material can be employed owing to power transmission and reception at a high frequency of 100 kHz or higher. Accordingly, this structure makes it possible to make transfer apparatus 1 and display apparatus 2 smaller in size, thickness and weight.

### Embodiment 13

Although the antenna mounted on the foregoing transfer apparatus 1 and display apparatus 2 was structured one in kind, it can be structured by a plurality of different kinds of antennas. FIG. 18 is a schematic view of an antenna in embodiment 13 of the invention, structured with two kinds of antennas on display apparatus 2. In FIG. 18, 2C is an IC having the circuit blocks shown in FIG. 11, 25S is an antenna for performing communication with transfer apparatus 1, and 25P is an antenna for supplying power from transfer apparatus 1. A power antenna 25P can be arranged around the display section in order to increase the screen area.

Here, those antennas can be structured by patterning a metal or organic material over a sheet and evaporating or applying it on the same layer as the display medium such as a microcapsule for use in the display section. Furthermore, in the storage battery, a sheet-formed capacitor can be arranged on the backside of the sheet. This structure can improve the power transmission efficiency on transfer apparatus 1 and display apparatus 2 and reduce the thickness of the apparatus.

### Embodiment 14

Display apparatus 2 can incorporate storage-battery remaining capacity detecting means. Furthermore, a remaining capacity detection result and status information as to connection status with the transfer apparatus can be displayed in a part of the display section of the electronic paper or in an exclusive display section provided separately.

This structure makes it possible to foresee the number of pages and speed of display rewrite and to grasp the communication status with the transfer apparatus, thus enabling to confirm the use position of the display apparatus and the usability thereof during carriage.

In the electronic paper, the operation was explained on the electrophoretic scheme to make a display under electric field. However, the display medium of display paper can be controlled in display under the electric field of a liquid crystal or the like. It naturally possible to use another scheme that display can be held without relying upon power.

The electronic paper display system of the invention can display information on a highly-portable display apparatus and, further, can manage display information, display apparatus and electronic paper. Therefore, this can realize to reduce the useless output of paper and to manage the security of output information.

1. An electronic paper display system comprising:
a display apparatus, having;
an electronic paper unit for holding a display state in a power-free state and displaying an image information by an application of magnetism or an electric field,
a display-side communication unit for wirelessly transmitting and receiving information with a transfer apparatus, and
a recording unit for generating an image based on received information and recording the image to the electronic paper unit; and
a transfer apparatus, having;
a transfer-side communication unit for wirelessly transmitting and receiving information with the display apparatus; and
an interface circuit for connection to an information processing apparatus;
wherein an image information produced at the information processing apparatus is transmitted in non-contact to the display apparatus through the transfer apparatus.

2. The electronic paper display system according to claim 1, wherein the transfer apparatus and the information processing apparatus are configured in one body.

3. The electronic paper display system according to claim 1 or 2, wherein the information processing apparatus has an information processing program for producing and managing information to be outputted to the display apparatus;
the display apparatus has a discrete ID; and
the information processing apparatus executes the information processing program so as to recognize ID information about the display device from the transfer apparatus and produce and manage image information according to the ID recognized.

4. The electronic paper display system according to claim 3, wherein a wireless tag is used for mounting the discrete ID on the display apparatus.

5. The electronic paper display system according to claim 4, wherein the wireless tag is provided on at least one of the electronic paper unit and a display unit main body.

6. The electronic paper display system according to claim 1 or 2, wherein the transfer apparatus has a power feed function to feed power by an electromagnetic wave;
the display apparatus has a storage battery for generating power from an electromagnetic wave received from the transfer apparatus and storing the power.

7. The electronic paper display system according to claim 6, wherein the display apparatus has a detection unit for detecting a remaining capacity of the storage battery, to display a result of the detection.

8. The electronic paper display system according to claim 1 or 2, wherein the electronic paper unit is removable from the display apparatus.

9. The electronic paper display system according to claim 8, wherein the attachment/detachment mechanism for the electronic paper unit and the display apparatus is controlled according to the information processing program of the information processing apparatus.

10. The electronic paper display system according to claim 1 or 2, wherein the electronic paper unit has a display device in a structure sandwiching a developer by a sheet free of an electrode;
the display apparatus having:
a surface arranging an electrode in an entire surface thereof for resting the electronic paper unit thereon;
a line-type application recording head for writing image information to the electronic paper unit; and
a drive mechanism for the line-type application recording head;
wherein an electric field is applied to between the electrode and the application recording head, so as to move the application recording head relative to the electronic paper unit or to move the electronic paper unit relative to the application recording head.

11. The electronic paper display system according to claim 1 or 2, wherein the electronic paper unit has a display device in a structure sandwiching a developer by a sheet free of an electrode;
the display apparatus has:
a lid, having a surface arranging an electrode in an entire surface thereof so as to sandwich the electronic paper unit;
a multiplicity of pixel electrodes arranged to write image information to the electronic paper unit, and a drive circuit for applying electric field to between the entire-surface electrode and the pixel electrodes.

12. The electronic paper display system according to claim 1 or 2, wherein the electronic paper unit has a display device in a structure sandwiching a developer by a sheet free of an electrode and a transparent sheet having an electrode only on one surface thereof, the display apparatus arranging a multiplicity of pixel electrodes for recording on an entire surface for resting the electronic paper unit thereon and having a drive circuit for driving the electrode.

13. The electronic paper display system according to any of claims 1 to 5, wherein the transfer apparatus has a discrete identification symbol and an interface circuit for connection to a communication network, the information processing apparatus being to exclusively manage a plurality of transfer apparatuses.

14. The electronic paper display system according to claim 1 or 2, wherein at least one of the transfer apparatus and the display apparatus has an alert unit for giving an alert to a user.

15. The electronic paper display system according to claim 1, wherein the transfer apparatus has a display unit.

16. The electronic paper display system according to any of claims 3 to 5, further including a plurality of information processing apparatuses each having the information processing program, the information processing programs on the apparatuses being to associatively operate thereby producing and managing image information.

17. The electronic paper display system according to claim 1 or 2, wherein the recording unit has a circuit structured of an organic semiconductor.

18. The electronic paper display system according to claim 1 or 2, wherein an antenna used on a communication unit in the display apparatus and transfer apparatus is formed of an organic material.
